(19) United States
(12) Patent Application Publication
(10) Pub. No.: US 2008/0036342 A1
(43) Pub. Date: Feb. 14, 2008

(54) Configurations and Methods for Modular Cabinetry

(76) Inventor: Ronald Heyer, Huntington Beach, CA (US)

Correspondence Address: FISH & ASSOCIATES, PC;ROBERT D. FISH, 2603 Main Street, Suite 1050, Irvine, CA, 92614-6232, US

(21) Appl. No.: 11/848,058

(22) Filed: Aug. 30, 2007

Related U.S. Application Data
(63) Continuation-in-part of application No. 11/131,724, filed on May 17, 2005.
(60) Provisional application No. 60/572,135, filed on May 17, 2004.

(51) Int. Cl. A47B 47/00; A47B 96/14; A47G 29/02; B23P 19/00

(52) U.S. Cl. 312/257.1; 248/235; 29/700; 312/349

(57) ABSTRACT

Contemplated modular and preferably self-squaring cabinets are assembled onto a wall or ceiling using one or more mounting rails and two or more bulkheads to form a structure in which substantially the entire load of the cabinet is supported by the bulkheads and mounting rails. Top and bottom front rails preferably complete the frame structure to which then a face frame, side, top, and bottom walls are coupled. Consequently, as the bulkheads substantially form the entire load bearing structure, it should be appreciated that the face frame, side walls, shelves, doors, top and bottom walls can be manufactured from light-weight materials. Moreover, contemplated cabinets allow in situ manufacture in a highly simplified manner and further allow refurbishing the cabinets without unmounting the cabinet from the wall.

This application is a continuation-in-part of U.S. application Ser. No. 11/131724, which was filed May 17, 2005, and which claims priority to U.S. provisional patent application 60/572135, filed May 17, 2004, both of which are incorporated by reference herein.

### FIELD OF THE INVENTION

The field of the invention is modular cabinetry, and especially wall-mounted cabinetry.

### BACKGROUND OF THE INVENTION

Numerous wall mounted furniture pieces are known in the art, and all or almost all of the currently known wall mounted furniture pieces are assembled prior to mounting to the wall. Prefabrication of wall mounted furniture advantageously simplifies, or completely eliminates any required assembly. However, as side, top, and bottom walls are typically load bearing structures, the weight of prefabricated wall mounted furniture if often substantial, and generally requires at least two persons to safely install the furniture. Furthermore, adjustment in distance from the wall, as well as leveling out such furniture is frequently challenging as the entire weight needs to be held by a person until the correct position of the furniture is achieved. Worse yet, storage requirements for prefabricated furniture is significant, and the sheer size of such furniture often exceeds transport capabilities of most customers that have not a truck or other cargo vehicle.

To alleviate at least some of the problems with preassembled furniture, modular furniture can be used. For example, U.S. Pat. No. 4,432,590 describes shelves and cabinetry in which grooved posts are used together with angle elements to erect a shelf or cabinet. While such modular system is relatively simple to erect, various disadvantages remain. Among other things, such system still requires pre-assembly of the entire cabinet before the cabinet is installed in place. Similarly, U.S. Pat. No. 5,848,711 teaches a modular shelf system in which wall-mounted support rails are used to hold to vertical posts, which then serve as a basis for further assembly. The weight of the structure in the '711 patent is further supported by the floor using adjustable bolts. Such system can advantageously be mounted into place and thus overcomes the shortcoming of the structure in the '590 patent. However, structure in the '711 patent is entirely unsuitable for hanging cabinets as there is no floor support for the structure.

Therefore, while numerous wall mounted and modular furniture configurations are known in the art, all or almost all of them suffer from significant disadvantages. Therefore, there is still a need to provide improved wall hanging furniture, and especially self-squaring cabinetry.

### SUMMARY OF THE INVENTION

The present invention is directed to modular and preferably self-squaring cabinets and methods for same in which the cabinet is configured such as to allow stepwise assembly onto a static surface (e.g., wall or ceiling). Most preferably, contemplated cabinets and other structures have first and second distinct mounting rails that are configured to releasably retain a bulkhead that serves as the primary weight-bearing structure in the cabinet or other structure. Typically, the bulkhead includes a mounting element that allows adjusting the distance of the bulkhead from the static surface, while a locking element is configured to prevent change of an angle that is formed between an imaginary vertical plane through the bulkhead and an imaginary vertical plane through the mounting rail.

In one aspect of the inventive subject matter, a modular cabinet assembly includes a first mounting rail having a first depth and a second mounting rail having a second depth, wherein the first depth is greater than the second depth. A pair of bulkheads is configured to allow coupling of the bulkheads to the first and second mounting rails via respective first and second mounting elements, wherein the second mounting element is configured to allow changing of a distance between the bulkhead and the second mounting rail. Contemplated cabinets further comprise at least one of a top front rail and a bottom front rail, each configured to allow coupling of the at least one of the top front rail and the bottom front rail to the bulkhead. Consequently, it should be appreciated that the cabinet is assembled such that substantially the entire load of the cabinet is transferred to the mounting rails via the pair of bulkheads.

Preferably, the bulkhead is configured as a rectangle, or has a X-shaped, M-shaped, or U-shaped configuration. While it is typically preferred that the bulkhead is prefabricated, it is also contemplated that the bulkhead can be assembled from a plurality of parts. Alternatively, or additionally, at least one of the dimensions of the bulkhead (and/or face plate) may be adjustable (e.g., telescoping). Furthermore, it is generally preferred that the mounting rail is horizontally mounted to a wall and the bulkhead is coupled to the mounting rail at a 90 degree angle.

In further preferred aspects, the bulkhead and at least one of the top front rail and the bottom front rail are configured to prevent change of an angle that is formed between an imaginary vertical plane through the bulkhead and an imaginary vertical plane through the mounting rail. Additionally, or alternatively, the cabinet comprises (a) a locking element that slidably engages with at least one of the mounting rails and that further engages with the bulkhead, or (b) a locking element that is coupled to the bulkhead and lockingly engages with at least one of the mounting rails, wherein the locking element is configured to prevent change of an angle that is formed between an imaginary vertical plane through the bulkhead and an imaginary vertical plane through the mounting rail.

Most preferably, at least one of the mounting elements is configured to allow slidable engagement with at least one of the mounting rails, wherein the first mounting element may be integrally formed with the bulkhead or may be coupled to the bulkhead via a tensioned rod that passes through substantially the entire bulkhead. While numerous manners of adjustment are deemed suitable, it is generally preferred that the second mounting element has an oppositely threaded portion, an eccentric portion, and/or a guide channel to thereby allow changing of the distance between the bulkhead and the second mounting rail. Furthermore, it is preferred that the top front rail and/or the bottom front rail have an L-shaped profile, and that the cabinet is assembled without a contiguous top back rail and/or bottom back rail. Bulkheads will typically comprise at least one of a door hinge, and a shelf support, and may further include a connector element that allows releasable coupling of a decorative outer side wall, a decorative inner side wall, a decorative back wall, a decorative top wall, and/or a decorative bottom wall. It is also contemplated that a face frame is coupled to the pair of bulkheads, the top front rail, and/or the bottom front rail.

Thus, in another aspect of the inventive subject matter, a kit for constructing a modular cabinet according to the inventive subject matter includes a bulkhead, a top front rail, a bottom front rail, a first mounting rail, and/or a second mounting rail, along with an instruction to assemble the cabinet such that substantially the entire load of the cabinet is transferred to the mounting rails via the pair of bulkheads.

In another aspect of the inventive subject matter, the inventor also contemplates a method of installing a cabinet that comprises the steps of coupling to a static surface (a) a first mounting rail having a first depth and (b) a second mounting rail having a second depth, wherein the first depth is greater than the second depth. In another step, a pair of bulkheads is coupled to the first and second mounting rails via respective first and second mounting elements, and in yet another step, the distance between the bulkhead and the second mounting rail is changed by using the second mounting element. In another step of contemplated methods, at least one of a top front rail and a bottom front rail are coupled to the pair of bulkheads, and at least one of a face frame, a door, a decorative outer side wall, a decorative inner side wall, a decorative back wall, a decorative top wall, and a decorative bottom wall is coupled to the bulkheads. Therefore, the cabinet is assembled such that substantially the entire load of the cabinet is transferred to the mounting rails via the pair of bulkheads.

Various objects, features, aspects and advantages of the present invention will become more apparent from the following detailed description of preferred embodiments of the invention, along with the accompanying drawing.

### BRIEF DESCRIPTION OF THE DRAWING

FIG. 1 is a schematic illustration of a modular cabinet assembly according to the inventive subject matter.

FIG. 2 is a schematic detail illustration of a mounting rail with optional locking element according to the inventive subject matter.

FIG. 3 is a schematic illustration of a portion of a modular cabinet assembly according to the inventive subject matter.

FIG. 4 is a schematic illustration of alternative configurations of bulkheads according to the inventive subject matter.

### DETAILED DESCRIPTION

The inventor has discovered that furniture, and especially wall and/or ceiling mounted furniture can be manufactured from a plurality of components in which the furniture is assembled onto a static surface. Preferably, the static surface is a surface in a building, and most preferably a wall or ceiling. In one particularly preferred aspect of the inventive subject matter, the furniture is a wall mounted modular cabinet that is mounted to the wall using mounting rails, which in turn support two bulkheads that transfer substantially all of the vertical load (deadweight and weight of contents) of the cabinet to the mounting rail. Most typically, the cabinet frame is completed by adding a top front rail and/or a bottom front rail (and/or a face frame). In further contemplated furniture items, the side walls of the cabinet as well as the top and bottom and face plate (which may in less preferred aspects include the doors and/or drawers), and optionally shelves, are coupled to the bulkheads.

The term “bulkhead” as used herein refers to a structure in a furniture item that transfers substantially all (i.e., greater 80%, and more typically at least 90%) of the vertical load of the cabinet to one or more mounting rails, wherein the structure extends in one dimension to at least 40% of the height (top to bottom) of the sidewall of the furniture item and extends in another dimension to at least 40% of the width (front to back) of the sidewall of the furniture, wherein at least one of the sidewalls, the top, the bottom, and the face plate is coupled to the structure, and wherein the vertical load includes the weight of the cabinet as well as any items placed into the cabinet. Thus, it should be recognized that the sidewall is expressly excluded from the meaning of the term “bulkhead”. As also used herein, the term “vertical load” refers to the weight force component of the furniture that is perpendicular to an absolute horizontal (typically level ground).

In one particularly preferred aspect of the inventive subject matter, a modular furniture, and particularly a modular wall-mounted cabinet includes a first and a second bulkhead coupled to a pair of mounting rails, wherein the mounting rails have different depths and are configured to be coupled to a wall or ceiling. Contemplated furniture items include a cabinet top, a cabinet bottom, a cabinet side, a shelf, and/or a cabinet face plate, each of which is coupled to the first and second bulkheads. Where desired, one or more squaring brackets may be coupled to the bulkhead such that the bracket prevents change of an angle that is formed between an imaginary vertical plane through the bulkhead and an imaginary vertical plane through the rail. Alternatively, or additionally, the top and/or bottom front rail are configured to prevent change of an angle that is formed between an imaginary vertical plane through the bulkhead and an imaginary vertical plane through the mounting rail. For example, the rails may include mating elements that engage and retain the rail with the bulkhead in only a predetermined angle. In another example, the rails may include squaring brackets and (e.g., sliding) connectors that fix the rail to the bulkhead. In still further contemplated examples, the rail may include one or more holes that allow coupling of the rail to the bulkhead in a fixed position.

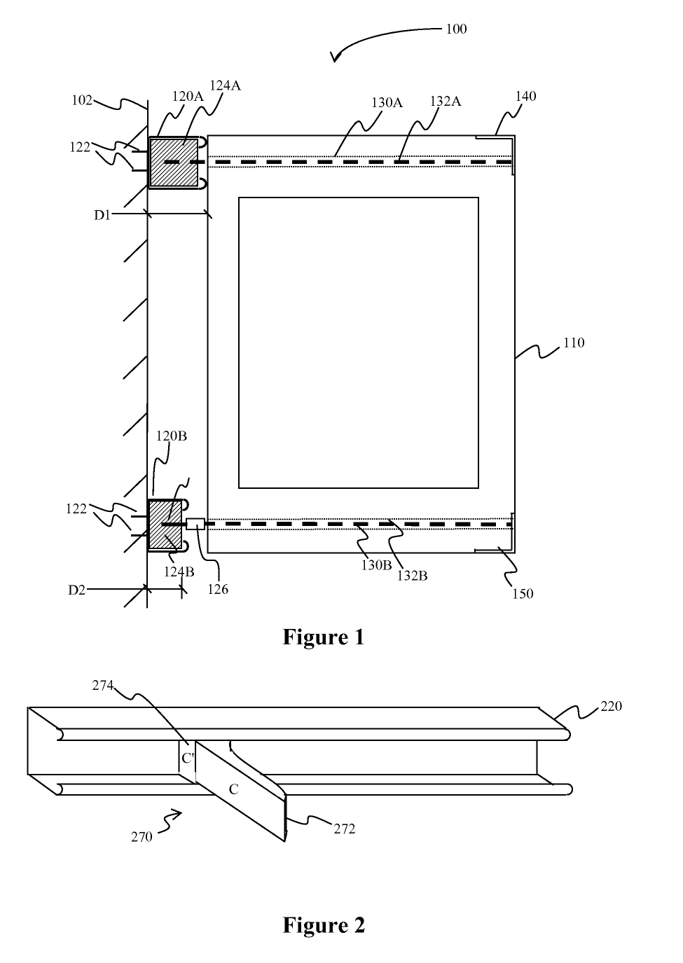

In one exemplary and particularly preferred aspect of the inventive subject matter as depicted in FIG. 1, a wall-mounted cabinet assembly 100 is shown in which a bulkhead 110 is mounted to a wall 102 via upper and lower mounting rails 120A and 120B, respectively. The mounting rails 120A and 120B are preferably affixed to a stud in a wall by a plurality of screws 122. It should be pointed out that the upper mounting rail 120A has a greater depth (see D1) as compared to the lower mounting rail 120B (see D2). Within channels formed by the mounting rails 120A and 120B are (slidably engaged and retained) upper and lower mounting elements 124A and 124B, respectively. In the example of FIG. 1, the bulkhead 110 is coupled to the rails via upper and lower tensioned rods (130A and 130B) that run across the span of the bulkhead through respective upper and lower channels 132A and 132B. Most preferably, the rods have threaded ends, wherein one end is threadedly secured to the mounting element and wherein the other end is (optionally threadedly) secured to the bulkhead. Upon tightening of the threadable connection between the rod and the mounting element, the rod becomes tensioned and reduces, if not even completely avoids weathervaning movement of the bulkhead.

To adjust for proper plumbing of the bulkhead, the lower mounting element may include adapter 126, preferably a nut with two opposite threads, wherein the first thread engages with the rod 130B and wherein the second thread engages with the lower mounting element 124B. In such configuration, it should be appreciated that simple turning of the nut in one direction or the other will increase or decrease the distance of the lower portion of the bulkhead relative to the wall. Viewed from another perspective, plumbing can be achieved (and even reversed) in a simple and effective manner after the frame has been mounted to the wall. Top front rail 140 and bottom front rail 150 are preferably L-shaped rails and releasably mounted to the bulkheads. However, alternative shapes (e.g., flat rails, or U-shaped rails) are also deemed suitable. Where desirable, one or more squaring brackets (not shown) may be coupled to the rails and/or bulkhead to reinforce and maintain a desired angle between the rail and the bulkhead. Alternatively, the top and/or bottom front rails may have a structure that maintains predetermined angle between a vertical plane through the rail and bulkhead. For example, a fixed spatial relationship may be forced by mating connectors and/or screws that secure the rails to the bulkhead.

Where desirable, a locking element may be provided to maintain a predetermined angle between a vertical plane through the rail and bulkhead, wherein the locking element is either part of or affixed to the bulkhead, or wherein the locking element is a slidable element that has an engagement surface (preferably with a connector that locks the surface to the bulkhead) with the bulkhead as shown in FIG. 2. Here, the locking element 270 is similar to the mounting element in that the locking element has a portion 274 that is slidably coupled and retained by a channel formed in the mounting rail 220, wherein portion 272 provides an engagement surface to contact the bulkhead. Coupling point C may be realized as a bolt, screw, or other manner of attachment of the portion 272 to the bulkhead, while coupling point C′ may be realized as a pin, screw, or other element that releasably coupled the mounting element to portion 274 of the locking element.

Alternatively, the bulkhead may also include a locking element that releasably and preferably slidably engages with a mounting rail to thereby maintain the predetermined angle between a vertical plane through the rail and bulkhead. For example, the locking element may be a tab extending from the bulkhead that slidably engages with the rail (preferably the outer lip of the rail). In another example, the bulkhead may have a channel along its surface (e.g., parallel to the channel 132A of FIG. 1) that allows insertion and retention of a locking element that is then moved from the front of the frame assembly towards the rail, wherein the locking element then contacts a portion of the rail while in the channel of the bulkhead to thereby maintain the predetermined angle between a vertical plane through the rail and bulkhead. Similarly, it should be appreciated that the configuration of mounting elements may also vary considerably, so long as such elements still allow releasable coupling of the bulkhead to the rail. For example, the mounting element may be integrally formed with or permanently coupled to the bulkhead, and optionally further comprise a squaring bracket that is configured to maintain an angle between the rail and the bulkhead (e.g., using a triangular element between bulkhead and rail).

It should be especially noted that using contemplated configurations a cabinet or other piece of furniture can be assembled on a wall in a level manner and predetermined distance from a wall simply by positioning the mounting rails in a proper position as the remaining components will provide predetermined angles that force the cabinet into a properly squared and plumbed configuration. In contrast, commonly used wall mounted cabinets are pre-assembled and then mounted to the wall, necessitating most adjustments with the cabinet suspended mid-air. Needless to say, such endeavor can be challenging, especially where only a single person mounts the cabinet to the wall. Moreover, it should be particularly appreciated that contemplated frame assemblies will effectively provide a structure in which substantially the entire load of the cabinet is transferred to the mounting rails via the pair of bulkheads.

Among other advantages, the cabinets according to the inventive subject matter will allow significant reduction of storage/shelf space in a wholesale and retail environment as the complete cabinet can be stored in its parts. Moreover, due to the load-bearing structure of the bulkheads, remaining components can be fabricated in a decorative manner. Thus, the thickness of the walls, bottom, and top can be drastically reduced, and therefore provide additional reduction is shipping costs. Still further, and viewed from yet another perspective, it should be appreciated that cabinets can be manufactured without a contiguous top and/or bottom back rail, and more typically entirely without a top and bottom back rail.

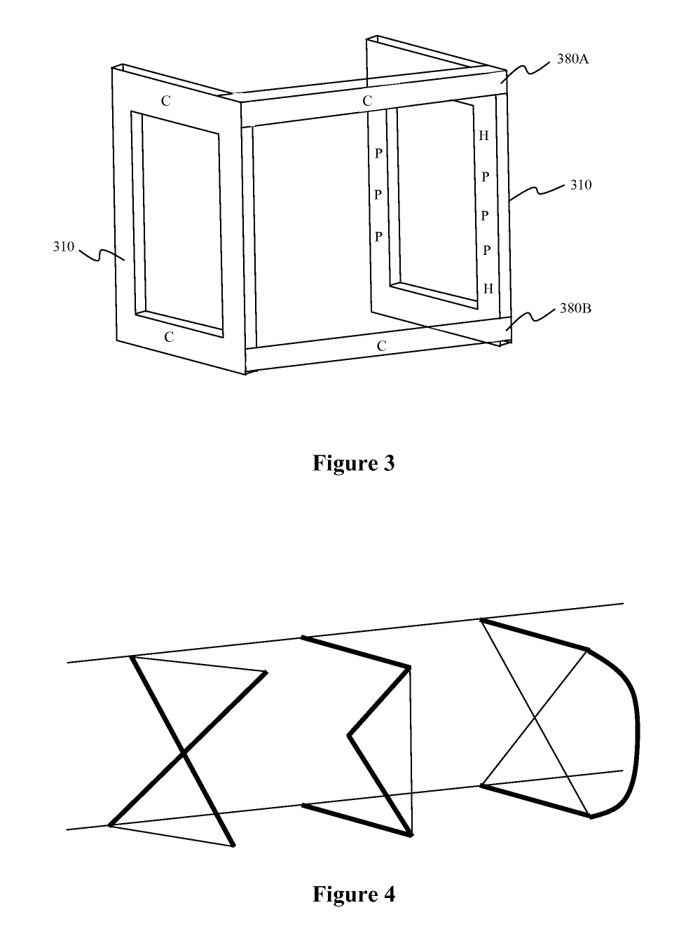

Once the mounting rails, bulkheads, and (where desired top and bottom front rails) are coupled to the wall in a desired position, a decorative cabinet top/bottom, decorative sidewalls, and decorative rear wall are then coupled to the bulkheads, preferably in a releasable manner. As used herein, the term “decorative” refers to the element as providing only aesthetic function. Therefore, under the scope of the definition provided herein, decorative elements will not provide load-bearing and/or load-transferring function. Coupling of a face frame completes the wall mounted cabinet (the face frame may include one or more doors, or the doors can be attached to the bulkhead via hinges). FIG. 3 exemplarily illustrates a frame assembly with bulkheads 310, top front rail 380A, and bottom front rail 380B (mounting rails and mounting elements are not shown). Attachment points P for one or more shelves are preferably implemented in the bulkhead as conventional shelf supports (e.g., as openings for pins, as protrusions, etc.), while the bulkhead also provides one or more coupling points for door hinges (marked as H; e.g., implemented as holes or mounting plates). There are numerous manners of coupling the face frame, decorative sides, top, and bottom panels to the bulkhead, and all manners of releasably attaching are deemed suitable herein. For example, snap-connectors (marked as connector elements C), channels, or hangers may be attached to or formed in the bulkhead. Most typically, furniture items contemplated herein will be provided as a set that allows complete installation of the furniture item. However, it should be recognized that individual components may also be provided, and especially as a kit with assembly instructions.

Therefore, a method of installing a cabinet may include a step of coupling to a static surface (a) a first mounting rail having a first depth and (b) a second mounting rail having a second depth, wherein the first depth is greater than the second depth, and a further step of coupling a pair of bulkheads to the first and second mounting rails via respective first and second mounting elements. Where needed, the method may also include a step of changing the distance between the bulkhead and the second mounting rail by using the second mounting element. In yet another step, at least one of a top front rail and a bottom front rail are coupled to the pair of bulkheads, and a face frame, a door, a decorative outer side wall, a decorative inner side wall, a decorative back wall, a decorative top wall, and/or a decorative bottom wall are coupled to at least one bulkhead so that the cabinet is assembled such that substantially the entire load of the cabinet is transferred to the mounting rails via the pair of bulkheads.

Most preferably, the mounting rails are fabricated from a metal, metal alloy, fiberglass, carbon-containing material, synthetic polymer, or combination thereof. However, alternative materials are also deemed suitable and include wood and fibrous materials. Regardless of the material, it is generally contemplated that the dimensions of the mounting rail may vary considerably, and suitable dimensions will at least in part depend on the particular use of the furniture. For example, where the furniture is a wall-mounted cabinet, or a bank of cabinets, suitable mounting rails may have a length of between 5 inches (or even less) to about 10 feet or more. Suitable thickness and heights will typically be in the range of about 1/32 inch (or even less) to 3 inches or more. Furthermore, suitable mounting rails may also have a stepped, indented or otherwise shaped profile that allows engagement of the mounting element and/or bulkhead with the mounting rail in a predetermined position. For example, indentations or grooves in the mounting rail may direct corresponding portions of the bulkhead and/or mounting element such that the bulkhead can only be mounted in a perpendicular angle (e.g., vertical) relative to the position of the mounting rail (typically horizontal). Thus, suitable mounting rails may include a U-shaped, T-shaped, or W-shaped profile, or an otherwise shaped profile. Similarly, the mounting rail may be configured to (e.g., slidingly) engage with a squaring bracket such that the squaring bracket couples the bulkhead to the mounting rail.

Moreover, contemplated mounting rails may have one or more elements that facilitate horizontal adjustment. For example, a mounting rail may include a level (e.g., water or laser), and/or a device that allows adjustment of the height of the rail relative to the ground while the mounting rail is coupled to the wall. Among other things, such device may include a channel through which a screw or nail proceeds into the wall, wherein the position of the channel is variable relative to the remaining mounting rail. Alternatively, or additionally, contemplated rails may also include a mechanism that allows adjustment of the distance of the rail relative to the ground while the mounting rail is coupled to the wall.

With respect to the bulkheads, it is generally preferred that the bulkheads have a frame configuration, and most preferably a rectangular frame configuration, wherein the frame includes a plurality of hollow elements with rectangular cross section that are welded or otherwise coupled to each other to form a frame with a predetermined size. Alternatively, the frame may also be fabricated as a single-piece element. Regardless of the particular configuration, it is generally preferred that the bulkheads have sufficient stiffness to prevent buckling and or warping. Most preferably, the frame materials are light-weight materials (e.g., metal, metal alloy, fiberglass, carbon-containing material, synthetic polymer, or combinations thereof), and suitable frames may further include stabilizing components (e.g., diagonal cross-bars or wires, corrugated elements, etc.) to further improve mechanical strength. Alternatively, contemplated bulkheads may also have numerous shapes other than a rectangular or square configuration, and particularly contemplated alternative configurations include an X-shaped configuration, an M-shaped configuration, and a U-shaped configuration as exemplarily depicted in FIG. 4.

As discussed above, suitable bulkheads may be pre-assembled, in unitary configuration (e.g., welded or otherwise assembled into one piece), or may be provided as a plurality of elements that are assembled by a user. In further preferred aspects, the bulkhead may also be configured to allow change in length in a least one dimension prior and/or after coupling of the bulkhead to the mounting rail. For example, contemplated bulkheads may include telescoping portions, or removable portions having one length that can be exchanged with other portions having another length. Thus, it should be recognized that furniture can be customized to a specific dimension while retaining a modular character. Still further and where desired, contemplated bulkheads may also include a cover or other structure coupled to the frame that further increases mechanical strength and/or provides additional functionality. For example, contemplated additional elements may include corrugated covers that increase buckling strength and provide additional options for coupling shelves or drawers to the bulkhead.

As the bulkhead in preferred configurations supports the sidewalls, the furniture top, the furniture bottom, the face plate, the back wall, and/or the shelves, it is generally preferred that the bulkhead has a width of at least 40% of the height (top to bottom), more preferably at least 50%, even more preferably at least 65% and most preferably at least 80% to 95% of the sidewall of the furniture. Similarly, contemplated bulkheads also extend in another dimension to at least 40% of the height (top to bottom), more preferably at least 50%, even more preferably at least 65% and most preferably at least 80% to 95% of the width (front to back) of the sidewall of the furniture. Such preferred configuration is reflected in a rectangular frame as depicted in FIGS. 1 and 3. To improve appearance, it should further be appreciated that the frame may be covered by a polymer coat or even a polymer (or other material) pocket that entirely hides the frame.

Where squaring brackets are used, it is generally preferred that the squaring bracket is (permanently or removably) coupled to the bulkhead and/or mounting element such that the squaring bracket engages with the bulkhead and the mounting rail to thereby prevent change of a angle that is formed between the mounting rail and the bulkhead. For example, a triangle-shaped squaring bracket may include one portion that permanently or removably connects the mounting rail to the bulkhead angle, wherein the connection may be achieved by mating pins and notches, bolts, screws, or snap-connectors. Thus, it should be recognized that all structures that reduce, and more typically eliminate weathervaning of the bulkhead relative to the mounting rail are deemed suitable for use herein.

The cabinet top, the cabinet bottom, the cabinet side, the shelf, and the cabinet face plate may vary substantially, and it should be recognized that all known shapes, sizes, and materials are deemed suitable so long as at least one of the cabinet top, the cabinet bottom, the cabinet side, the shelf, and the cabinet face plate are configured to be coupled to the bulkhead. Most preferably, however, it is contemplated that the cabinet top, the cabinet bottom, the cabinet side, the shelf, and the cabinet face plate (optionally including doors and/or drawers) are fabricated from a light weight material as these components need not carry significant loads, and do not contribute to the stability of the furniture item. Therefore, suitable materials particularly include synthetic polymers, wood, metal, and all reasonable combinations thereof, and especially include fiberglass, synthetic polymers, and wood-containing composite materials, which optionally may be coupled to a veneer on at least one side.

Suitable dimensions will typically be those common in the art of furniture making, however, smaller and larger sizes are also contemplated. For example, where the furniture item is a decorative rather than functional item, smaller sizes may be advantageous. On the other hand, larger sizes are also deemed suitable, especially where the furniture item is part of an industrial cabinet. Therefore, contemplated shelves, cabinet tops, and cabinet bottoms will typically have a width (side-to-side) and depth (front-to-back) that is between 3 inches to about 6 feet, and 2 inches and 4 feet, respectively. Similarly, contemplated sidewalls will typically have a height (top-to-bottom) and width (front-to-back) that is between 3 inches to about 6 feet, and 2 inches and 4 feet, respectively. Consequently, the faceplate will typically have dimensions of about 2 inches to about 6 feet in the two largest dimensions (side-to-side and top-to-bottom). The thickness of preferred cabinet tops, cabinet bottoms, cabinet sides, shelves, and cabinet face plates is typically between about ⅛ inch to ½ inch. However, and depending on the particular configurations, smaller thicknesses are also deemed suitable. Similarly, and especially where the component is exposed to at least some mechanical load (e.g., face plate with door, or shelf), larger thicknesses are also considered suitable. Doors and/or drawers in contemplated furniture items may also be coupled to a component other than the faceplate, and most preferably to the bulkhead. Additionally, it is contemplated that at least one of the cabinet top, the cabinet bottom, the cabinet side, the shelf, and the cabinet face plate are configured to change length in at least one dimension. For example, change in dimension may be implemented by incorporating sliding or telescoping elements, or modular elements that releasably engage with another element (e.g., via dove-tail connectors, pins, etc.)

With respect to coupling the components of the furniture item contemplated herein, it should be recognized that at least one of the bulkhead, mounting rail, mounting elements, cabinet top, the cabinet bottom, the cabinet side, the shelf, and the cabinet face plate comprises a connector element that is configured to allow coupling of the at least one of the cabinet top, the cabinet bottom, the cabinet side, the shelf, and the cabinet face plate to at least one of the first and second bulkheads. There are numerous manners of coupling known in the art, and all of such connectors and connector elements are deemed suitable for use herein. However, it is generally preferred that the connection made is a releasable connection, and in even more preferred elements, the position of an element that is connected to another element can be adjusted in at least one dimension while the two elements are coupled to each other. Therefore, suitable connectors include dowels, screws, clamps, locks, pins, etc.

Thus, specific embodiments of modular self-squaring cabinetry have been disclosed. It should be apparent, however, to those skilled in the art that many more modifications besides those already described are possible without departing from the inventive concepts herein. The inventive subject matter, therefore, is not to be restricted except in the spirit of the present disclosure and the contemplated claims. Moreover, in interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A modular cabinet assembly comprising:
a first mounting rail having a first depth and a second mounting rail having a second depth, wherein the first depth is greater than the second depth;
a pair of bulkheads configured to allow coupling of the bulkheads to the first and second mounting rails via respective first and second mounting elements;
wherein the second mounting element is configured to allow changing of a distance between the bulkhead and the second mounting rail;
at least one of a top front rail and a bottom front rail, each configured to allow coupling of the at least one of the top front rail and the bottom front rail to the bulkhead; and
wherein the cabinet is assembled such that substantially the entire load of the cabinet is transferred to the mounting rails via the pair of bulkheads.

2. The modular cabinet assembly of claim 1 wherein at least one bulkhead comprises a portion having a rectangular configuration, an X-shaped configuration, an M-shaped configuration, or a U-shaped configuration.

3. The modular cabinet assembly of claim 1 further wherein the bulkhead and at least one of the top front rail and the bottom front rail are configured to prevent change of an angle that is formed between an imaginary vertical plane through the bulkhead and an imaginary vertical plane through the mounting rail.

4. The modular cabinet assembly of claim 1 further comprising (a) a locking element that slidably engages with at least one of the mounting rails and that further engages with the bulkhead, or (b) a locking element that is coupled to the bulkhead and lockingly engages with at least one of the mounting rails, wherein the locking element is configured to prevent change of an angle that is formed between an imaginary vertical plane through the bulkhead and an imaginary vertical plane through the mounting rail.

5. The modular cabinet assembly of claim 1 wherein at least one of the mounting elements is configured to allow slidable engagement with at least one of the mounting rails.

6. The modular cabinet assembly of claim 1 wherein the first mounting element is integrally formed with the bulkhead.

7. The modular cabinet assembly of claim 1 wherein the first mounting element is coupled to the bulkhead via a tensioned rod that passes through substantially the entire bulkhead.

8. The modular cabinet assembly of claim 1 wherein the second mounting element has at least one of an oppositely threaded portion, an eccentric portion, and a guide channel to thereby allow changing of the distance between the bulkhead and the second mounting rail.

9. The modular cabinet assembly of claim 1 wherein the at least one of the top front rail and the bottom front rail have an L-shaped profile.

10. The modular cabinet assembly of claim 1 wherein the cabinet is assembled without at least one of a contiguous top back rail and bottom back rail.

11. The modular cabinet assembly of claim 1 wherein at least one of the bulkheads comprises at least one of a door hinge, and a shelf support.

12. The modular cabinet assembly of claim 1 wherein at least one bulkheads comprises a connector element that allows releasable coupling of at least one of a decorative outer side wall, a decorative inner side wall, a decorative back wall, a decorative top wall, and a decorative bottom wall.

13. The modular cabinet assembly of claim 1 further comprising a face frame coupled to at least one of the pair of bulkheads, the top front rail, and the bottom front rail.

14. The modular cabinet assembly of claim 1 wherein the pair of bulkheads is fabricated from a metal or a metal alloy.

15. A kit for constructing a cabinet comprising:
at least one of a bulkhead, a top front rail and a bottom front rail, a first mounting rail, and a second mounting rail;
wherein in the cabinet:
(a) the first mounting rail has a first depth and the second mounting rail has a second depth, and wherein the first depth is greater than the second depth;
(b) wherein the pair of bulkheads is configured to allow coupling of the bulkheads to the first and second mounting rails via respective first and second mounting elements;
(c) wherein the second mounting element is configured to allow changing of a distance between the bulkhead and the second mounting rail;
(d) wherein at least one of the top front rail and the bottom front rail are configured to allow coupling of the at least one of the top front rail and the bottom front rail to the bulkhead; and
an instruction to assemble the cabinet such that substantially the entire load of the cabinet is transferred to the mounting rails via the pair of bulkheads.

16. The kit of claim 15 further comprising at least one of a face frame, a door, a decorative outer side wall, a decorative inner side wall, a decorative back wall, a decorative top wall, and a decorative bottom wall.

17. A method of installing a cabinet comprising:
coupling to a static surface (a) a first mounting rail having a first depth and (b) a second mounting rail having a second depth, wherein the first depth is greater than the second depth;
coupling a pair of bulkheads to the first and second mounting rails via respective first and second mounting elements;
changing a distance between the bulkhead and the second mounting rail by using the second mounting element;
coupling at least one of a top front rail and a bottom front rail to the pair of bulkheads; and
coupling to at least one of the pair of bulkheads at least one of a face frame, a door, a decorative outer side wall, a decorative inner side wall, a decorative back wall, a decorative top wall, and a decorative bottom wall;
wherein the cabinet is assembled such that substantially the entire load of the cabinet is transferred to the mounting rails via the pair of bulkheads.

18. The method of claim 17 wherein at least one of the mounting elements is configured to allow slidable engagement with at least one of the mounting rails.

19. The method of claim 17 wherein the first mounting element is integrally formed with the bulkhead.

20. The method of claim 17 wherein the first mounting element is coupled to the bulkhead via a tensioned rod that passes through substantially the entire bulkhead.
